(19) United States
(12) Patent Application Publication
(10) Pub. No.: US 2026/0350862 A1
(43) Pub. Date: Nov. 5, 2026

(54) METHODS AND SYSTEMS FOR GENERATING A CONTEXT-AWARE TEXTURE IMAGE

(71) Applicant: SAMSUNG ELECTRONICS CO., LTD., Suwon-si (KR)

(72) Inventors: Yathish REDDY M, Bengaluru (IN); Savesh ., Bengaluru (IN); Gihun KIM, Suwon-si (KR); Yongjun KIM, Suwon-si (KR); Daehun KIM, Suwon-si (KR); Rishabh KAUSHIK, Bengaluru (IN); Addanki SANKARARAO, Bengaluru (IN); Raj Narayana GADDE, Bengaluru (IN)

(73) Assignee: SAMSUNG ELECTRONICS CO., LTD., Suwon-si (KR)

(21) Appl. No.: 19/721,100

(22) Filed: Jun. 26, 2026

Related U.S. Application Data
(63) Continuation of application No. PCT/KR2026/004831, filed on Mar. 26, 2026.

(30) Foreign Application Priority Data
Mar. 26, 2025 (IN) 202541028603
Nov. 13, 2025 (IN) 202541028603

(51) Int. Cl. G06T 11/10; G06T 7/20; G06V 10/60; G06V 20/70

(52) U.S. Cl. CPC G06T 11/10; G06T 7/20; G06V 10/60; G06V 20/70

(57) ABSTRACT

A method, performed by an electronic device, for generating a context-aware texture image based on a visual frame may be provided. The method may include generating a texture map based on at least one of the visual frame or a segmentation map of the visual frame. The method may include generating at least one auxiliary map based on the visual frame. The method may include generating a comprehensive weight map based on the segmentation map, the texture map, and the at least one auxiliary map. The method may include generating the context-aware texture image based on the comprehensive weight map. The context-aware texture image may comprise noise generated for at least one region in the visual frame.

### CROSS-REFERENCE TO RELATED APPLICATIONS

This application is a Continuation Application of International Application No. PCT/KR2026/004834 filed on Mar. 26, 2026, which claims priority to Indian Patent Application number 202541628603, filed Nov. 13, 2025, at the Office of the Controller General of Patents, Designs and Trade Marks, which claims priority to of Provisional Indian Patent Application number 202541028603, filed Mar. 26, 2025, at the Office of the Controller General of Patents, Designs and Trade Marks, the disclosures of which are incorporated herein in their entireties by reference.

### BACKGROUND

### 1. Technical Field

The present disclosure relates to digital imaging, and more particularly relates to a system and a method for generating a context-aware texture image.

### 2. Background of the Related Art

In the domain of mobile photography, texture may play a pivotal role in enhancing the visual appeal of images and videos. The presence of fine texture details may contribute significantly to user experience by imparting realism and depth to captured content in an image. However, when high-scale zoom is employed, particularly through digital zoom mechanisms, there may be a noticeable degradation in quality of the image. The digital zoom may involve cropping and upscaling of the image, which may often result in the softening of details and textures. The softening effect may cause the image to appear “painted” or artificial, thereby diminishing natural aesthetics and overall visual fidelity of the image.

Modern smartphones are equipped with multiple camera sensors, including wide-angle, ultra-wide-angle, and telephoto lenses. In addition to the multiple camera sensors, high-end smartphones may also include multiple telephoto sensors that support different optical zoom levels, such as 3× and 5×. In contrast, mid-range smartphones may only include wide-angle and ultra-wide-angle sensors, thereby limiting their optical zoom capabilities. These sensors may operate at distinct optical zoom levels, for example, 0.6× for ultra-wide-angle and 1.0× for wide-angle. When a zoom is applied beyond the native optical zoom range, the image may be digitally enhanced to achieve magnifications up to 20×. In the case of telephoto sensors, the image captured at 3× or 10× optical zoom may be further digitally upscaled to reach zoom levels as high as 30× or even 100×. However, such excessive upscaling may often lead to substantial loss of texture and detail, resulting in a visually unappealing “painted” effect.

FIG. 1 illustrates a representation of a digitally upscaled image, in accordance with the related art. As depicted, an image 102 comprises content 104, which has been digitally upscaled to achieve a zoom level of approximately 100×. Due to the extent of digital magnification, the content 104 may exhibit significant degradation in texture quality. The degradation in texture quality may result in a visually unappealing appearance, as evidenced by the softened and painted-like texture observed in content portions 106 and 108.

Further, methods for texture enhancement, including noise rendering techniques, may be broadly classified into traditional texture synthesis methods and deep learning-based methods. Both categories may exhibit limitations that hinder their applicability for real-time, on-device deployment.

The traditional texture synthesis methods, such as Perlin noise, Simplex noise, Gaussian noise, and fractal noise, are commonly employed to simulate texture. FIG. 2 illustrates an implementation of traditional texture synthesis methods on an image 202, in accordance with the related art. The traditional texture synthesis methods may generally apply a uniform enhancement across the image 202 without adapting to the local scene content to obtain image 204. Furthermore, the traditional texture synthesis methods may require extensive parameter tuning to achieve realistic results for specific scenes, thereby limiting their scalability and effectiveness.

Further, the deep learning-based methods, including generative models such as Generative Adversarial Networks (GANs) and Variational Autoencoders (VAEs), may be capable of producing high-quality textures. However, the generative models may be computationally intensive and unsuitable for real-time processing on mobile devices. Further, the generative models may often apply uniform noise across the image, which may result in over-enhancement in some regions and under-enhancement in others. Additionally, the generative models may lack context awareness and may fail to distinguish between smooth and highly textured regions.

Hence, there is a need for improved digital imaging systems and methods that overcome the above-mentioned and other related problems.

### SUMMARY

This summary is provided to introduce a selection of concepts, in a simplified format, that are further described in the detailed description of the disclosure. This summary is neither intended to identify key or essential inventive concepts of the invention nor is it intended to determine the scope of the invention. In an embodiment, a method, performed by an electronic device, for generating a context-aware texture image based on a visual frame may be provided. In an embodiment, the method may include generating a texture map based on at least one of the visual frame or a segmentation map of the visual frame. In an embodiment, the texture map may indicate a texture type for at least one region in the visual frame. In an embodiment, the method may include generating at least one auxiliary map based on the visual frame. In an embodiment, the at least one auxiliary map may indicate at least one contextual parameter associated with refinement of a texture of the visual frame. In an embodiment, the method may include generating a comprehensive weight map based on the segmentation map, the texture map, and the at least one auxiliary map. In an embodiment, the comprehensive weight map may indicate a noise intensity for each pixel in the visual frame. In an embodiment, the method may include generating the context-aware texture image based on the comprehensive weight map. In an embodiment, the context-aware texture image may comprise noise generated for at least one region in the visual frame.

In an embodiment, a system for generating a context-aware texture image based on a visual frame may be provided. In an embodiment, the system may comprise at least one processor, and memory coupled with the at least one processor. In an embodiment, instructions, stored in the memory, when executed by the at least one processor, may cause the system to generate a texture map based on at least one of the visual frame or a segmentation map of the visual frame, In an embodiment, the texture map may indicate a texture type for at least one region in the visual frame. In an embodiment, instructions, when executed by the at least one processor, may cause the system to generate at least one auxiliary map based on the visual frame. In an embodiment, the at least one auxiliary map may indicate at least one contextual parameter associated with refinement of a texture of the visual frame. In an embodiment, instructions, when executed by the at least one processor, may cause the system to generate a comprehensive weight map based on the segmentation map, the texture map, and the at least one auxiliary map. In an embodiment, the comprehensive weight map may indicate a noise intensity for each pixel in the visual frame. In an embodiment, instructions, when executed by the at least one processor, may cause the system to generate the context-aware texture image based on the comprehensive weight map. In an embodiment, the context-aware texture image may comprise noise generated for at least one region in the visual frame.

In an embodiment, an electronic device for generating a context-aware texture image based on a visual frame may be provided. In an embodiment, the electronic device may comprise at least one processor, and memory coupled with the at least one processor. In an embodiment, instructions, stored in the memory, when executed by the at least one processor, may cause the system to generate a texture map based on at least one of the visual frame or a segmentation map of the visual frame, In an embodiment, the texture map may indicate a texture type for at least one region in the visual frame. In an embodiment, instructions, when executed by the at least one processor, may cause the electronic device to generate at least one auxiliary map based on the visual frame. In an embodiment, the at least one auxiliary map may indicate at least one contextual parameter associated with refinement of a texture of the visual frame. In an embodiment, instructions, when executed by the at least one processor, may cause the electronic device to generate a comprehensive weight map based on the segmentation map, the texture map, and the at least one auxiliary map. In an embodiment, the comprehensive weight map may indicate a noise intensity for each pixel in the visual frame. In an embodiment, instructions, when executed by the at least one processor, may cause the electronic device to generate the context-aware texture image based on the comprehensive weight map. In an embodiment, the context-aware texture image may comprise noise generated for at least one region in the visual frame.

To further clarify the advantages and features of the disclosure, a more particular description of the disclosure will be rendered by reference to an embodiment thereof, which are illustrated in the appended drawing. It is appreciated that these drawings depict only typical embodiments of the invention and are therefore not to be considered limiting its scope. The disclosure will be described and explained with additional specificity and detail in the accompanying drawings.

### BRIEF DESCRIPTION OF THE DRAWINGS

These and other features, aspects, and advantages of the disclosure will become better understood when the following detailed description is read with reference to the accompanying drawings in which like characters represent like parts throughout the drawings, wherein:

FIG. 1 illustrates an exemplary representation of a digitally upscaled image, in accordance with the related art;

FIG. 2 illustrates an implementation of traditional texture synthesis methods on an image, in accordance with the related art;

FIG. 3 illustrates a diagram depicting an environment for generating a context-aware texture image, in accordance with an embodiment of the present disclosure;

FIG. 4 illustrates a block diagram of a system for generating the context-aware texture image, in accordance with an embodiment of the present disclosure;

FIG. 5 illustrates an exemplary one or more noise samples for one or more regions, in accordance with an embodiment of the present disclosure;

FIG. 6 illustrates generation of a segmentation map based on a visual frame, in accordance with an embodiment of the present disclosure;

FIG. 7 illustrates generation of a texture map, in accordance with an embodiment of the present disclosure;

FIG. 8 illustrates generation of a per-pixel illumination map, in accordance with an embodiment of the present disclosure;

FIG. 9 illustrates generation of a zoom and weight map, in accordance with an embodiment of the present disclosure;

FIG. 10 illustrates generation of an optical flow map, in accordance with an embodiment of the present disclosure;

FIG. 11 illustrates generation of a context-aware texture image, in accordance with an embodiment of the present disclosure; and

FIG. 12 illustrates a process flow of a method for generating the context-aware texture image, in accordance with an embodiment of the present disclosure.

Further, skilled artisans will appreciate that those elements in the drawings are illustrated for simplicity and may not have necessarily been drawn to scale. For example, the flow charts illustrate the method in terms of the most prominent steps involved to help to improve understanding of an embodiment of the present invention. Furthermore, in terms of the construction of the device, one or more components of the device may have been represented in the drawings by conventional symbols, and the drawings may show only those specific details that are pertinent to understanding an embodiment of the present invention so as not to obscure the drawings with details that will be readily apparent to those of ordinary skill in the art having the benefit of the description herein.

### DETAILED DESCRIPTION

For the purpose of promoting an understanding of the principles of the present disclosure, reference will now be made to the various embodiments, and specific language will be used to describe the same. It will nevertheless be understood that no limitation of the scope of the present disclosure is thereby intended, such alterations and further modifications in the illustrated system, and such further applications of the principles of the present disclosure as illustrated therein, being contemplated as would normally occur to one skilled in the art to which the present disclosure relates.

It will be understood by those skilled in the art that the foregoing general description and the following detailed description are explanatory of the present disclosure and are not intended to be restrictive thereof.

Whether or not a certain feature or element was limited to being used only once, it may still be referred to as “one or more features” or “one or more elements,” “at least one feature,” or “at least one element.” Furthermore, the use of the terms “one or more” or “at least one” feature or element does not preclude there being none of that feature or element, unless otherwise specified by limiting language, including, but not limited to, “there needs to be one or more . . . ” or “one or more elements are required.”

Reference is made herein to some “embodiments.” It should be understood that an embodiment is an example of a possible implementation of any features and/or elements of the present disclosure. Some embodiments have been described for the purpose of explaining one or more of the potential ways in which the specific features and/or elements of the proposed disclosure fulfill the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

The terms “comprises”, “comprising”, or any other variations thereof, are intended to cover a non-exclusive inclusion, such that a process or method that comprises a list of operations does not include only those operations but may include other operations not expressly listed or inherent to such process or method. Similarly, one or more devices or sub-systems or elements or structures or components preceded by “comprises . . . a” does not, without more constraints, preclude the existence of other devices or other sub-systems or other elements or other structures or other components or additional devices or additional sub-systems or additional elements or additional structures or additional components.

The term “couple” and the derivatives thereof refer to any direct or indirect communication between two or more elements, whether or not those elements are in physical contact with each other. The terms “transmit”, “receive”, and “communicate”, as well as the derivatives thereof, encompass both direct and indirect communication. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of A, B, or C” may indicate only A, only B, only C, both A and B, both A and C, both B and C, all of A, B, and C, or variations thereof. Similarly, the term “set” means one or more. Accordingly, the set of items may be a single item or a collection of two or more items.

Moreover, multiple functions described below may be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data may be permanently stored and media where data may be stored and later overwritten, such as a rewritable optical disc or an erasable memory device.

Any particular and all details set forth herein are used in the context of an embodiment and therefore should NOT be necessarily taken as limiting factors to the attached claims. The attached claims and their legal equivalents can be realized in the context of an embodiment other than the ones used as illustrative examples in the description below.

Further, skilled artisans will appreciate those elements in the drawings that are illustrated for simplicity and may not have necessarily been drawn to scale. For example, the flow charts illustrate the method in terms of the most prominent steps involved to help improve understanding of an embodiment of the present disclosure. Furthermore, in terms of the construction of the device, one or more components of the device may have been represented in the drawings by conventional symbols, and the drawings may show only those specific details that are pertinent to understanding an embodiment of the present disclosure so as not to obscure the drawings with details that will be readily apparent to those of ordinary skill in the art having the benefit of the description herein.

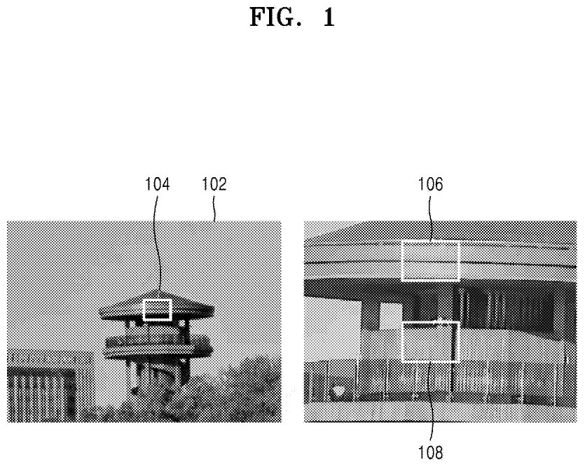

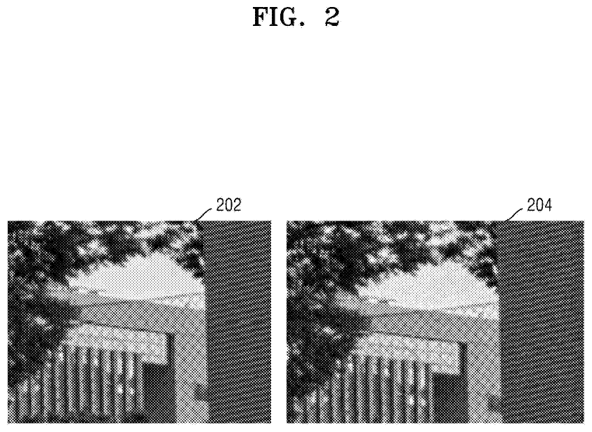

For the sake of clarity, the first digit of a reference numeral of each component of the present disclosure is indicative of the Figure number, in which the corresponding component is shown. For example, reference numerals starting with digit “1” are shown at least in FIG. 1. Similarly, reference numerals starting with digit “2” are shown at least in FIG. 2. Further, similar reference numerals have been used to represent similar components in the Figures.

It should be noted that the terms “evidence” and “at least one proof of evidence” have been used interchangeably throughout the description and the drawings. Further, the terms “policy” and “one or more policy configurations” have been used interchangeably throughout the description and the drawings.

An embodiment of the present disclosure may dynamically apply different types of noise based on scene context, lighting conditions, zoom levels, and motion analysis.

An embodiment of the present disclosure will be described below in detail with reference to the accompanying drawings.

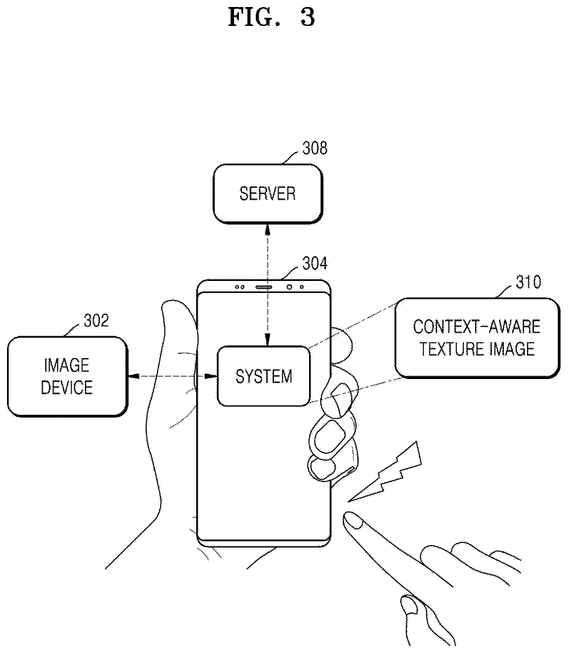

FIG. 3 illustrates a diagram depicting an environment 300 for generating a context-aware texture image 310, in accordance with an embodiment of the present disclosure.

Referring to FIG. 3, the environment 300 depicts an implementation of system 306. In an embodiment, the system 306 may be implemented in server 308. In an embodiment, the system 306 may be implemented within an electronic device 304.

The environment 300 may include an imaging device 302 and the electronic device 304. The imaging device 302 may include one or more camera sensors configured to capture an image. In an embodiment, the electronic device 304 may incorporate the imaging device 302 such that the electronic device 304 includes the one or more camera sensors. In an embodiment, the electronic device 304 may exist as a separate entity from the imaging device 302, and receive the captured image from the imaging device 302. Furthermore, the system 306 may be configured to facilitate the generation of a context-aware texture image 310 based on the captured image.

In an embodiment, the system 306 may include software, hardware, a combination of software and hardware, an in-built application on the electronic device 304, or an application to be installed and operated on the electronic device 304 in communication with a network interface (not shown). The system 306 may also be accessible at the electronic device 304 via the server (a cloud-based server), and available remotely from the electronic device 304.

In an embodiment where the system 306 is located outside the electronic device 304 (e.g., the electronic device 304 including the imaging device 302), the network interface may be configured to provide network connectivity and enable communication between the system 306 and the electronic device 304. The network connectivity may be provided via a wireless connection or a wired connection. For example, the network connectivity may be provided via cellular technology, such as 3rd Generation (3G), 4th Generation (4G), 5th Generation (5G), pre-5G, 6th Generation (6G), Bluetooth, Local Area Network (LAN), Wi-Fi, cable, or any other wired/wireless communication technology.

In an embodiment, the system 306 may be configured to receive a visual frame (e.g., the captured image) from an imaging device 302. In a non-limiting example, the imaging device 302 may include, but is not limited to, a digital camera, a smartphone, and a sensor-enabled display device. In a non-limiting example, the visual frame may include at least one of a still image and a video frame. Further, the visual frame may correspond to a discrete unit of visual information, typically comprising pixel data associated with a scene or an object captured at a particular instant in time. The imaging device 302 may be integrated within the electronic device 304, such as a smartphone, tablet, wearable device, or any other user equipment capable of image acquisition.

In an embodiment, the system 306 may be configured to generate a texture map based on at least one of the visual frame or a segmentation map of the visual frame. In a non-limiting example, the texture map may indicate a texture type for one or more regions in the visual frame. In an example, the texture map may indicate image features in the one or more regions in the visual frame. In an embodiment, the texture type may indicate at least one of a classification of texture characteristics or a quantitative texture intensity (e.g., edge density). In a non-limiting example, the one or more regions may correspond to distinct portions or segments within a captured image or video frame that may be identified, classified, or processed independently. For example, in a visual frame depicting a landscape, the texture map may indicate that a first region corresponds to a smooth texture type with low edge density (such as sky), while a second region corresponds to a rough texture type with high spatial frequency components (such as foliage).

In an embodiment, the system 306 may be configured to generate one or more auxiliary maps based on the visual frame. In an embodiment, the system 306 may generate one or more auxiliary maps based on at least one of an inertial sensor data obtained from the imaging device 302 or a zoom scale obtained from the imaging device 302. In a non-limiting example, the one or more auxiliary maps may indicate one or more contextual parameters associated with the refinement of the texture of the visual frame. In a non-limiting example, the inertial sensor data may correspond to one or more measurements obtained from inertial sensors such as accelerometers, gyroscopes, or magnetometers that are integrated within or operatively coupled to the imaging device 302. The inertial sensors may provide data indicative of the motion, orientation, acceleration, and angular velocity of the imaging device 302 during image capture. In a non-limiting example, the zoom scale may correspond to a numerical or categorical value indicative of the magnification level applied by the imaging device 302 during image acquisition. The zoom scale may be expressed as an optical zoom factor (such as 2×, 5×) or a digital zoom ratio and may reflect an extent to which field of view has been narrowed or expanded.

In an embodiment, the one or more auxiliary maps may include at least one of a per-pixel illumination map, a zoom and weight map, or an optical flow map.

In an embodiment, the per-pixel illumination map may correspond to a data structure or image representation, where each pixel encodes the illumination intensity or lighting intensity at that specific spatial location. The illumination intensity may be derived from scene lighting models, reflectance properties, or estimated using photometric techniques.

In an embodiment, the zoom and weight map may be used to selectively emphasize or de-emphasize portions of the image, such as in multi-scale image processing, attention-based neural networks, or adaptive rendering. The zoom component may define the degree of enlargement or focus for specific regions. The weight component may guide blending, fusion, or prioritization operations based on pixel-level or region-level significance.

In an embodiment, the optical flow map may correspond to a map that shows how each pixel in the image moves from one frame to the next in a video or image sequence. The optical flow map may represent the movement using arrows or vectors that indicate direction and speed of motion. The optical flow map may correspond to an organized layout of visible motion in a scene caused by the movement of one or more camera sensors or objects.

In an embodiment, the one or more auxiliary maps may be generated using at least one of an intensity estimator, a zoom and lighting estimator, and a temporal consistency estimator.

In a non-limiting example, the intensity estimator may generate the one or more auxiliary maps representing the spatial distribution of pixel intensities, e.g. the per-pixel illumination map, which may be used to enhance contrast, detect features, or guide further image processing operations. The intensity estimator may be implemented using statistical analysis, machine learning models, or neural networks trained on visual data.

In a non-limiting example, the zoom and lighting estimator may generate the one or more auxiliary maps that reflect spatial and contextual variations in zoom and lighting, e.g. the zoom and weight map thereby enabling adaptive rendering, exposure correction, or scene understanding. The zoom and lighting estimator may utilize metadata, image gradients, or learned representations to infer zoom and lighting parameters.

In a non-limiting example, the temporal consistency estimator may generate the one or more auxiliary maps that capture motion vectors, frame-to-frame coherence, or stability of pixel attributes over time, e.g. the optical flow map. The temporal consistency estimator may employ optical flow techniques, recurrent neural networks, or temporal filtering methods.

Further, the one or more auxiliary maps may be used to refine the texture map by quantifying local scene properties such as motion regions and static regions. For the static regions across visual frames, such as walls, furniture, or other non-moving objects, noise patterns are maintained consistently across successive frames. The consistency ensures that visual artifacts such as flickering are avoided, thereby preserving the temporal coherence of the scene. In contrast, for high-motion regions, which include moving objects or areas affected by motion blur, the optical flow map may be generated using motion estimation techniques. For example, in the case of a moving car with a textured surface, the grain patterns are aligned with the direction and magnitude of motion.

Table 1, shown below, illustrates the application of noise on the texture map based on the scene properties.

TABLE 1

| Scene | Motion | | |
|---|---|---|---|
| properties | Magnitude | Noise Control | Example |
| Static | Low or | Consistent noise | Walls or furniture in |
| Regions | none | across frames. | static scenes maintain |
| | | | uniform noise. |
| High-Motion | High | Adjust dynamically | Moving a car or a |
| Regions | | based on motion. | person receives |
| | | | temporally coherent |
| | | | noise aligned with |
| | | | motion. |
| Transitional | Medium | Gradual adjustment | Panning shots ensure |
| Regions | | of noise intensity. | smooth transitions in |
| | | | noise distribution. |

In an embodiment, the system 306 may be configured to generate a comprehensive weight map based on the segmentation map, the texture map, and the one or more auxiliary maps. In a non-limiting example, the comprehensive weight map may indicate noise intensity for each pixel and each of one or more regions in the visual frame.

In a non-limiting example, the segmentation map may indicate labeling for each of the one or more regions in the visual frame with a corresponding category. For instance, the corresponding category may include, but is not limited to, semantic labels such as sky, skin, clothing, foliage, or artificial surfaces. Each region may be identified based on visual characteristics and may be classified accordingly to support scene understanding, segmentation, or further image processing.

In an embodiment, the system 306 may be configured to generate the context-aware texture image based on the comprehensive weight map. In an embodiment, the context-aware texture image may include noise generated for at least one region in the visual frame. In a non-limiting example, the context-aware texture image may indicate a textured map detailing region-specific noise level with corresponding noise sample among one or more noise samples, thereby improving and preserving clarity in the one or more regions of the visual frame. In a non-limiting example, the one or more noise samples may correspond to one or more instances of artificially or naturally generated data that represent random or structured variations.

In a non-limiting example, to receive the visual frame from the imaging device 302, the system 306 may be configured to obtain the visual frame from at least one of a memory of the imaging device 302 or a real-time visual frame captured by the imaging device 302. For example, the imaging device 302 may retrieve a previously stored image from the memory, such as a photograph taken earlier and saved in a storage module of the memory. Alternatively, the imaging device 302 may capture a live image using the one or more camera sensors, for instance, a video frame recorded during active operation.

In an embodiment, prior to generating the context-aware texture image, the system 306 may be configured to generate one or more noise samples selected from a plurality of noise generation machine learning (ML) models. Further, each of the plurality of noise generation ML models may correspond to a distinct texture class.

In a non-limiting example, the plurality of noise generation ML models may include, but are not limited to, a film grain generation model, a sensor-specific noise model, a mixed Gaussian noise model, a fractal noise model, and a texture-driven noise model.

In an embodiment, the film grain generation model may be used to replicate a granular texture typically observed in analog film photography, thereby producing cinematic or vintage effects.

In an embodiment, the sensor-specific noise model may generate noise patterns based on inherent characteristics of imaging sensors, including thermal noise, readout noise, or quantization artifacts.

In an embodiment, the mixed Gaussian noise model may introduce noise using a combination of Gaussian distributions, thereby simulating complex real-world noise with varying intensity and spread.

In an embodiment, the fractal noise model, such as Perlin noise, may produce smooth and natural-looking textures using fractal algorithms, which are commonly applied in procedural graphics and terrain generation.

In an embodiment, the texture-driven noise model may generate noise patterns influenced by existing textures in the image, thereby enabling context-aware noise synthesis that aligns with the visual structure of the scene.

In an embodiment, Table 2 illustrates the plurality of noise generation ML models, each configured to contribute distinct characteristics to the texture map for the purpose of generating the context-aware texture image.

TABLE 2

| Noise | | |
|---|---|---|
| generation | Contribution to | |
| ML models | Texture Map | Suggested usage |
| film grain | Adds aesthetic | Applied in bright texture |
| generation | randomness. | regions for visual appeal. |
| model | | |
| sensor- | Simulates device-specific | Replicates camera-specific |
| specific noise | noise characteristics. | imperfections. |
| model | | |
| shot noise | Mimics photon-based | Highlighted in bright |
| model | sensor noise (e.g., | regions with high |
| | Poisson distribution). | intensity variations. |
| uniform noise | Provides baseline random | Subtly added in plain or |
| model | noise distribution. | slightly dark regions. |
| fractal noise | Adds smooth, gradient- | Used for organic patterns |
| model | based noise for natural | like clouds or terrain. |
| | textures. | |
| mixed | Simulates layered noise | Applied in regions with |
| Gaussian | with varying intensity | high detail to create |
| noise model | and scale. | depth. |
| simplex noise | Produces coherent noise | Ideal for textures requiring |
| model | with reduced | subtle gradients like water |
| | computational cost. | ripples. |
| periodic noise | Repeats noise patterns | Used for tiles, fabrics, or |
| model | for structured surfaces. | periodic textures. |
| speckle noise | Adds small, high- | Applied in regions with fine- |
| model | intensity noise points. | grained textures like sand or |
| | | asphalt. |

In an embodiment, the system 306 may be configured to receive the visual frame from the imaging device 302. The system 306 may be configured to identify, using a machine learning model, the one or more regions in the visual frame based on visual features. In a non-limiting example, the visual features may include, but are not limited to, color information (such as Red, Green, Blue (RGB) values, hue, saturation), texture patterns (such as granularity, smoothness), shape descriptors (such as edges, contours), spatial positioning (such as coordinates, size), motion vectors (such as optical flow), depth cues (such as stereo disparity), and semantic labels (such as object classification). The system 306 may be configured to generate the segmentation map based on the identified one or more regions.

In an embodiment, to generate the texture map, the system 306 may be configured to receive the visual frame from the imaging device 302 and the segmentation map from the machine learning model. The system 306 may be configured to determine a semantic context for the at least one region in the visual frame based on the segmentation map. In a non-limiting example, the semantic context may correspond to meaningful classification or interpretation assigned to a region (among the one or more regions) within the visual frame, based on the segmentation map. The semantic context may provide information such as whether a region represents a road, a pedestrian, a vehicle, vegetation, or any other identifiable category.

The system 306 may be configured to determine one or more texture metrics from the visual frame for each of the one or more regions in the visual frame. The one or more texture metrics may indicate texture characteristics of the visual frame. In a non-limiting example, the texture metrics may include, but are not limited to, statistical measures such as contrast, entropy, homogeneity, energy, and correlation derived from gray-level co-occurrence matrices (GLCM), frequency-based features such as those obtained from wavelet transforms or Fourier analysis, and local descriptors such as Local Binary Patterns (LBP).

The system 306 may be configured to generate the texture map based on the one or more texture metrics for the one or more regions in the visual frame.

In an embodiment, the one or more auxiliary maps may include at least one of a per-pixel illumination map, a zoom and weight map, or an optical flow map. In an embodiment, to generate the one or more auxiliary maps comprising the per-pixel illumination map, the system 306 may be configured to compute one or more illumination values based on at least one of a brightness value for each pixel in the visual frame or a brightness value for each of the at least one region. In a non-limiting example, the one or more illumination values may indicate one or more quantifiable parameters indicative of the light intensity or brightness present in the visual frame, determined through the pixel-level and the region-level analysis. At the pixel level, the one or more illumination value may correspond to grayscale intensity or luminance component derived from an RGB color model. At the region level, the one or more illumination value may be computed as an average, median, or distribution of pixel intensities within a defined segment of the visual frame. The system 306 may be configured to generate the per-pixel illumination map based on the one or more illumination values.

The system 306 may be configured to adjust the one or more illumination values based on the inertial sensor data to compensate for motion-related illumination variation. The system 306 may be configured to generate the per-pixel illumination map based on the adjusted illumination values. The per-pixel illumination map may indicate a noise modulation for each of the one or more regions in the visual frame.

In an embodiment, to generate the zoom and weight map, the system 306 may be configured to compute a sensor gain weightage factor and a zoom weightage factor based on the visual frame and the zoom scale corresponding to the visual frame. The sensor gain weightage factor may indicate noise sensitivity of an image sensor used to capture the visual frame. The image sensor may be included in the one or more camera sensors of the imaging device 302. The zoom weightage factor may indicate a magnification-related noise for a current zoom level (e.g., a zoom level associated with the visul frame). The system 306 may be configured to generate the zoom and weight map based on the sensor gain weightage factor and the zoom weightage factor. In a non-limiting example, the zoom and weight map may indicate regions in the visual frame with varying noise levels.

In an embodiment, system 306 may be configured to adjust a noise level in the visual frame based on the sensor gain weightage factor and the zoom weightage factor. The system 306 may be configured to generate the zoom and weight map based on the adjusted noise level.

In an embodiment, to generate the optical flow map, the system 306 may be configured to compute one or more optical flow parameters based on the visual frame. In a non-limiting example, the one or more optical flow parameters may correspond to a set of motion-related descriptors that are computed based on the analysis of at least one visual frame and the temporal relationship with one or more subsequent or preceding visual frames. The one or more optical flow parameters may be derived by evaluating the changes in pixel intensities across consecutive visual frames, thereby capturing the apparent motion of objects, edges, or textures within the scene. The one or more optical flow parameters may include, but are not limited to, at least one of motion vectors, which represent direction and magnitude of pixel displacement, velocity fields, which describe spatial distribution of motion across the visual frame, or gradient-based information, such as spatial and temporal derivatives of image intensity. The system 306 may be configured to identify one or more motion-prone regions in the visual frame based on the one or more optical flow parameters and the inertial sensor data. The system 306 may be configured to generate the optical flow map based on the identified one or more motion-prone regions. In a non-limiting example, the optical flow map may indicate the at least one region of the visual frame being motion prone. In an embodiment, to generate the comprehensive weight map, the system 306 may be configured to obtain a baseline noise intensity for each of the one or more regions in the visual frame based on the segmentation map and the texture map. The system 306 may be configured to obtain a per-pixel weight by adjusting the baseline noise intensity based on the at least one auxiliary map. In an embodiment, the system 306 may be configured to refine the per-pixel weight contributions in each of the one or more regions based on predefined weight ranges. The system 306 may be configured to generate the comprehensive weight map based on the per-pixel weight (e.g., refined per-pixel weight contributions).

Table 3, shown below, depicts an example of the computation of the per-pixel weight based on the segmentation map, the texture map, and one or more auxiliary maps.

TABLE 3

| | Role in Weight | |
|---|---|---|
| Parameter | Computation | Key Considerations |
| Segmentation | Baseline region | Critical regions (faces, |
| Map | identification and semantic | skies) get lower noise. |
| | noise assignment. | |
| Context-Aware | Sets initial desired noise | Regions with higher |
| Texture Map | intensity based on local | texture energy are boosted. |
| | texture metrics. | |
| Per-pixel | Adjusts noise based on | Bright areas reduce noise; |
| Illumination | brightness; lower in bright, | darker areas may enhance |
| Map | higher in dark. | it. |
| Weight Map | Modulates noise relative to | High ISO areas: reduce |
| | exposure and sensor noise. | synthetic noise to avoid |
| | | over-saturation. |
| Zoom Map | Prioritizes details based on | Lower zoom ratio: less |
| | zoom ratio | enhancement. |
| | | Higher zoom: more |
| | | enhancement. |
| Optical Flow | Ensures noise stability in | High-motion areas receive |
| Map | high-motion regions to | reduced noise weights. |
| | prevent flickering. | |

In an embodiment, to generate the context-aware texture image 310, the system 306 may be configured to receive the comprehensive weight map and the one or more noise samples. The system 306 may be configured to determine a noise sample among the one or more noise samples for each of the one or more regions of the visual frame based on the comprehensive weight map. The system 306 may be configured to generate a context-based texture map, based on the determined noise sample, indicating the noise intensity and the noise sample for each of the at least one region. The system 306 may be configured to fuse the context-based texture map in the visual frame. The system 306 may be configured to generate the context-aware texture image based on the fusion.

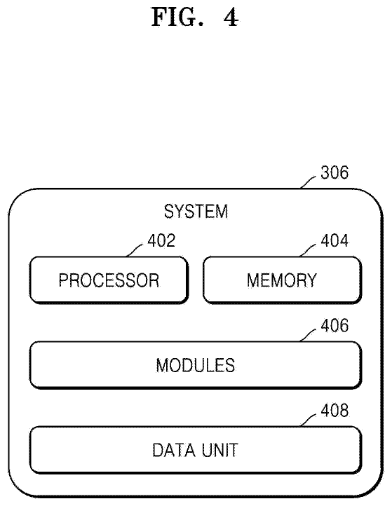

FIG. 4 illustrates a block diagram of the system 306 for generating the context-aware texture image, in accordance with an embodiment of the present disclosure.

In an embodiment, the system 306 may include at least one processor 402, memory 404, a plurality of modules 406, and a data unit 408. The at least one processor 402, the memory 404, the plurality of modules 406, and the data unit 408 may be communicably coupled with each other.

In an embodiment, the system 306 may be implemented in the electronic device 304. The electronic device may include the at least one processor 402, the memory 404, the plurality of modules 406, and the data unit 408.

In an embodiment, the at least one processor 402 may be in communication with the memory 404. The at least one processor 402 may be a single processing unit or several units, all of which could include multiple computing units. The at least one processor 402 may be implemented as one or more microprocessors, microcomputers, microcontrollers, digital signal processors, central processing units, state machines, logic circuitries, and/or any devices that manipulate signals based on operational instructions. Among other capabilities, the at least one processor 402 may be configured to fetch and execute computer-readable instructions and data stored in the memory 404.

In an embodiment, the memory 404 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

In an embodiment, the plurality of modules 406 may be configured to generate the context-aware texture image.

In an embodiment, the plurality of modules 406 may include a set of instructions that can be executed to cause the system 306 to perform any one or more of the methods disclosed. The system 306 may operate as a standalone device or may be connected, e.g., using a network, to other computer systems or peripheral devices. Further, while a single processing unit is illustrated, the term “processing unit” shall also be taken to include any collection of processing units, implemented across the system 306 that individually or jointly execute a set, or multiple sets, of instructions to perform one or more computer functions.

In an embodiment, the plurality of modules 406 may be implemented using one or more artificial intelligence (AI) units that may include a plurality of neural network layers. Examples of neural networks include, but are not limited to, Convolutional Neural Network (CNN), Deep Neural Network (DNN), Recurrent Neural Network (RNN), and Restricted Boltzmann Machine (RBM). Further, ‘learning’ may be referred to in the disclosure as a method for training a predetermined target device (for example, a robot) using a plurality of learning data to cause, allow, or control the target device to make a determination or prediction. Examples of learning techniques may include, but are not limited to, supervised learning, unsupervised learning, semi-supervised learning, or reinforcement learning. At least one of a plurality of CNN, DNN, RNN, RMB models and the like may be implemented to thereby achieve execution of the present subject matter's mechanism through an AI model. A function associated with an AI unit may be performed through the non-volatile memory, the volatile memory, and the processor. The at least one processor 402 may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor, such as a neural processing unit (NPU). One or a plurality of processors may control the processing of the input data in accordance with a predefined operating rule or artificial intelligence (AI) model stored in the non-volatile memory and the volatile memory. The predefined operating rule or artificial intelligence model may be provided through training or learning.

In an embodiment, the data unit 408, amongst other things, may include routines, programs, objects, components, data structures, and the like, which perform tasks or implement data types. The data unit 408 may also be implemented as signal processor(s), state machine(s), logic circuitries, and/or any other device or component that manipulates signals based on operational instructions. Further, the data unit 408 may be implemented in hardware, instructions executed by a processing unit, or by a combination thereof. The processing unit may comprise a processor, such as the at least one processor 402, a state machine, a logic array, or any other suitable device capable of processing instructions. The processing unit may be a general-purpose processor that executes instructions to cause the general-purpose processor to perform the required tasks, or the processing unit can be dedicated to performing the required functions. In an embodiment of the present disclosure, the data unit 408 may be machine-readable instructions (software) that, when executed by the at least one processor 402, perform any of the described functionalities.

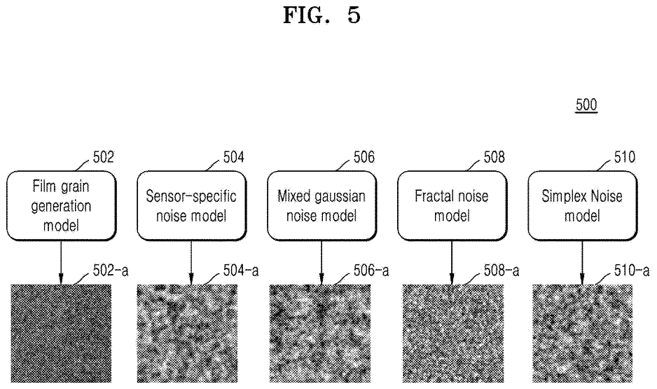

FIG. 5 illustrates an exemplary one or more noise samples 500 for the one or more regions, in accordance with an embodiment of the present disclosure.

As illustrated in FIG. 5, image 502-a depicts a noise sample generated by the film grain generation model 502, image 504-a depicts a noise sample generated by the sensor-specific noise model 504, image 506-a depicts a noise sample generated by the mixed gaussian noise model 506, image 508-a depicts a noise sample generated by the fractal noise model 508 and image 510-a depicts a noise sample generated by the simplex noise model 510.

In an embodiment, the at least one processor 402 of the system 306 may determine the noise sample among the one or more noise samples for the one or more regions based on the comprehensive weight map. The noise sample may be fused in the one or more regions of the visual frame to generate the context-aware texture image.

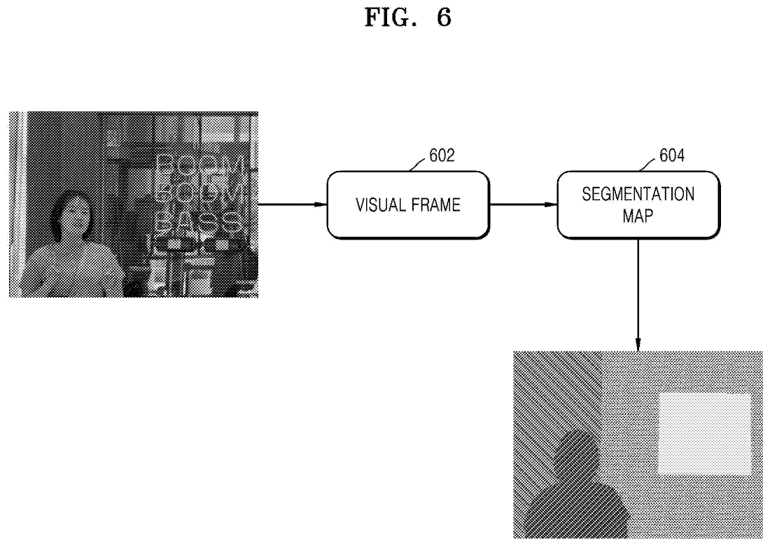

FIG. 6 illustrates the generation of the segmentation map from the visual frame, in accordance with an embodiment of the present disclosure.

As shown in FIG. 6, the visual frame 602 may be received by the system 306. In an embodiment, a deep learning-based image processing module may be employed by the system 306 to perform semantic segmentation at the pixel level. In an embodiment, the system 306 may utilize a trained deep neural network to analyze the visual frame and generate the segmentation map 604. The segmentation map may indicate labeling for each of the one or more regions in the visual frame with the corresponding category. For instance, the corresponding category may include, but is not limited to, semantic labels such as sky, skin, clothing, foliage, or artificial surfaces. Each region may be identified based on visual characteristics and may be classified accordingly to support scene understanding, segmentation, or further image processing.

As shown, the visual frame 602 may include an image of a girl situated within an indoor environment, such as a room. The room may include a transparent glass window and a signboard. Upon acquisition of the visual frame 602, the system 306 using the deep learning-based model may generate the segmentation map. The segmentation map may assign classification labels to each pixel based on the object or a structure represented therein. For instance, pixels corresponding to the girl's face and hands may be classified under the category “skin”, while pixels representing her clothing may be labeled as “fabric”. The background pixels depicting the room interior, including walls and furniture, may be categorized as “indoor elements”. The glass window may be identified as a “transparent surface”, and the signboard may be classified under “textual signage”.

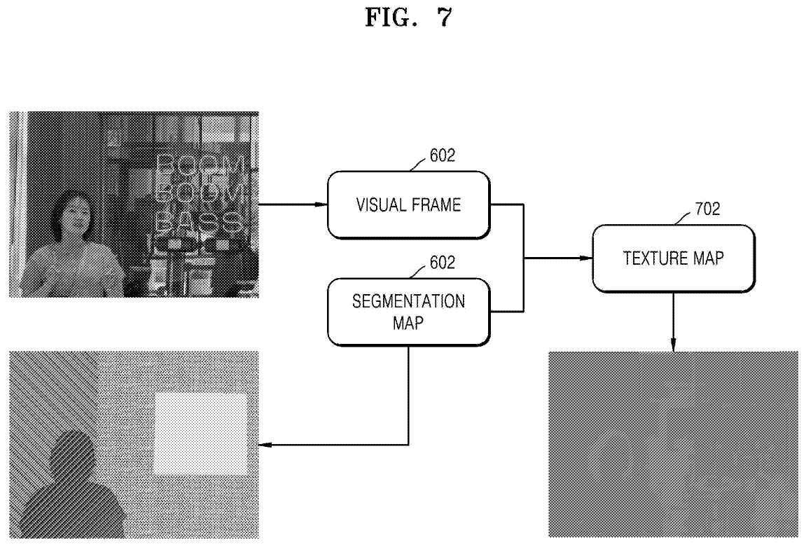

FIG. 7 illustrates the generation of the texture map 702, in accordance with an embodiment of the present disclosure.

In an embodiment, as shown in FIG. 7, to generate the texture map 702, the system 306 may receive the visual frame 602 from the imaging device 302 and the segmentation map 604 from the machine learning model.

The system 306 may determine the semantic context from the segmentation map and the one or more texture metrics from the visual frame 602, for each of the one or more regions in the visual frame 602. Accordingly, the system 306 may generate the texture map 702 for the one or more regions in the visual frame 602. The texture map 702 may specify the intended noise intensity for each segmented region or for each of the one or more regions.

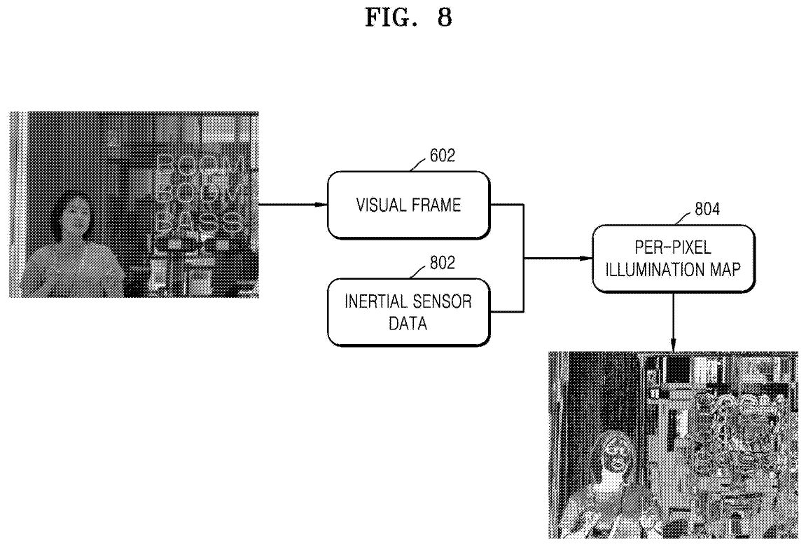

FIG. 8 illustrates the generation of the per-pixel illumination map 804, in accordance with an embodiment of the present disclosure.

In an embodiment, to generate the per-pixel illumination map 804, the system 306 may compute the one or more illumination values based on pixel and region analysis of the visual frame 602. Further, the system 306 may adjust the illumination values based on the inertial sensor data 802 to compensate for motion-related illumination variation. Accordingly, the system 306 may generate the per-pixel illumination map based on the adjusted illumination values. For example, pixels corresponding to the girl's face, being well-lit by ambient light, may be assigned low noise intensity so as to preserve subtle tonal gradients and facial contours. The regions representing her clothing, which may be partially shaded, may be attributed a moderate noise intensity to enhance the perception of fabric texture under variable lighting. The background region depicting a concrete wall in shadow may be designated a higher noise intensity so as to accentuate surface irregularities and depth. Further, the glass window, reflecting bright outdoor light, may be mapped with minimal noise intensity so as to retain clarity and specular highlights. Similarly, the signboard illuminated by artificial light may be associated with a controlled noise level to maintain legibility without introducing distortion.

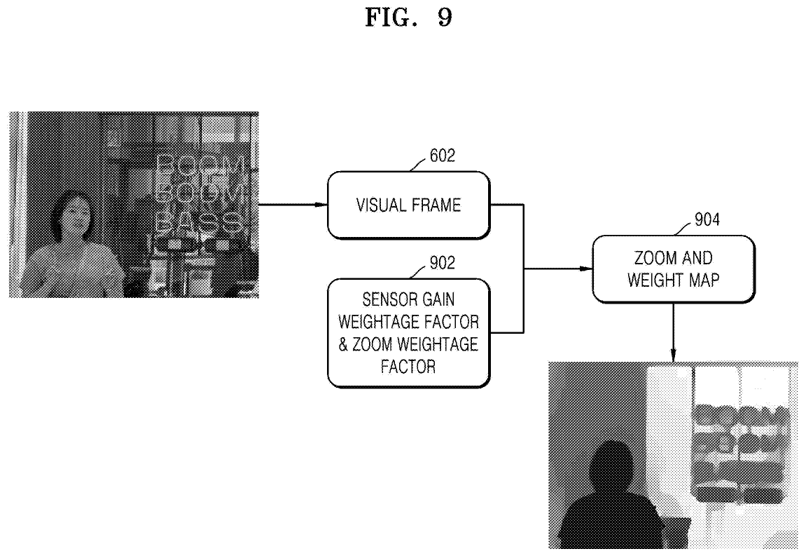

FIG. 9 illustrates the generation of the zoom and weight map 904, in accordance with an embodiment of the present disclosure.

In an embodiment, to generate the zoom and weight map 904, the system 306 may receive the visual frame 602. The system 306 may compute the sensor gain weightage factor and the zoom weightage factor based on the visual frame 602 and the zoom scale corresponding to the visual fram 602. The system 306 may generate the zoom and weight map 904 based on the sensor gain weightage factor and the zoom weightage factor. In an embodiment, the system 306 may adjust the noise level in the visual frame 602 and generate the zoom and weight map 904. For example, in a scenario where the visual frame 602 is captured under low-light conditions using a high International Standards Organization (ISO) setting, the visual frame 602 may inherently exhibit sensor-induced noise. In such cases, the system 306 may adjust the level of synthetic noise assigned to each region so as to avoid amplifying the existing noise artifacts. For instance, pixels corresponding to the girl's face, which may already contain fine-grained ISO noise, may be assigned minimal or no additional synthetic noise to preserve facial clarity. The clothing region, being less sensitive to noise perception, may be attributed a moderate level of synthetic noise to enhance texture realism. The background region, such as a dimly lit wall, may be designated a slightly higher noise level to simulate surface roughness without overwhelming the image altogether. Furthermore, the zoom ratio (e.g., zoom level) associated with the visual frame 602 or with the imaging device 302 may be evaluated to determine the degree of detail and potential texture softening. In cases where a high zoom ratio is detected, the system 306 may reduce the synthetic noise intensity across all regions to maintain perceptual sharpness and avoid introducing blur-like artifacts.

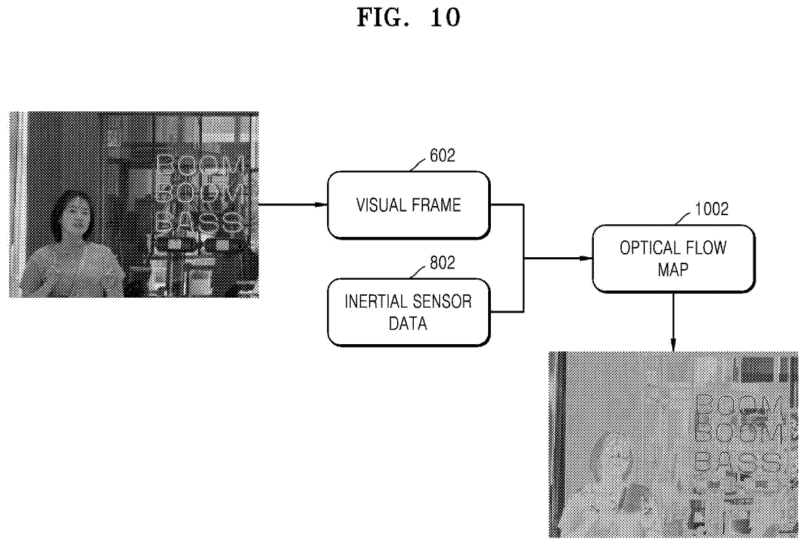

FIG. 10 illustrates the generation of the optical flow map 1002, in accordance with an embodiment of the present disclosure.

In an embodiment, to generate the optical flow map 1002, the system 306 may receive the visual frame 602. The system 306 may compute the one or more optical flow parameters based on the visual frame 602. Further, the system 306 may identify the one or more motion-prone regions in the visual frame 602 based on the one or more optical flow parameters and the inertial sensor data 802. Accordingly, the system 306 may generate the optical flow map 1002. For instance, the girl may be moving, such as walking or gesturing, while the signboard and the glass window remain static. Based on the analysis, the system 306 may identify the one or more regions corresponding to the girl as a motion-prone region within the visual frame 602. Accordingly, the optical flow map 1002 may be generated that visually encodes the magnitude and direction of motion across the visual frame 602 and highlights the motion-prone region associated with the girl.

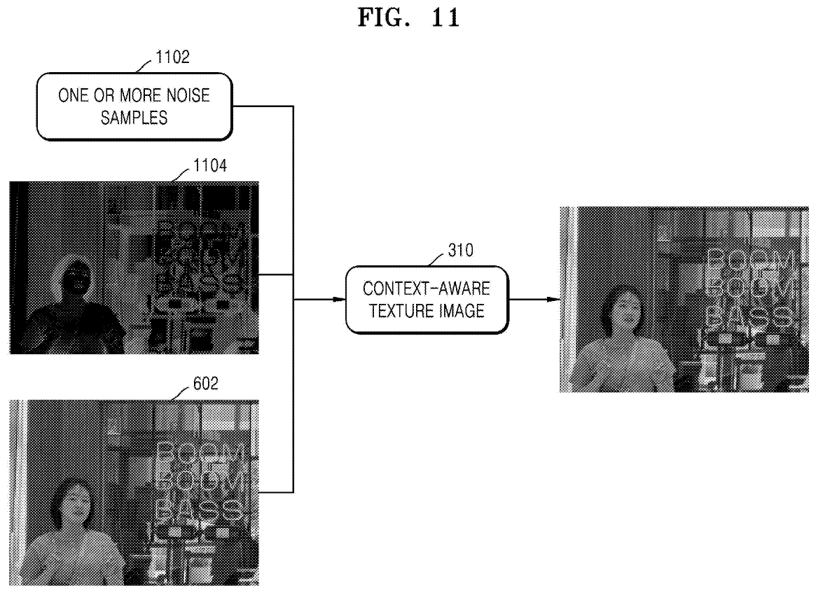

FIG. 11 illustrates the generation of the context-aware texture image 310, in accordance with an embodiment of the present disclosure.

In an embodiment, to generate the context-aware texture image 310, the system 306 may receive the one or more noise samples 1102, the comprehensive weight map 1104, and the visual frame 602. The system 306 may determine the noise sample among the one or more noise samples 1102 for each of the one or more regions based on the comprehensive weight map 1104. Further, the system 306 may fuse the noise sample in the one or more regions of the visual frame 602 and accordingly generate the context-aware texture image 310.

In an embodiment, the system 306 may generate a context-based texture map, based on the determined noise sample, indicating the noise intensity and the noise sample for each of the one or more regions. The system 306 may fuse the context-based texture map in the visual frame 602. The system 306 may generate the context-aware texture image 310 based on the fusion.

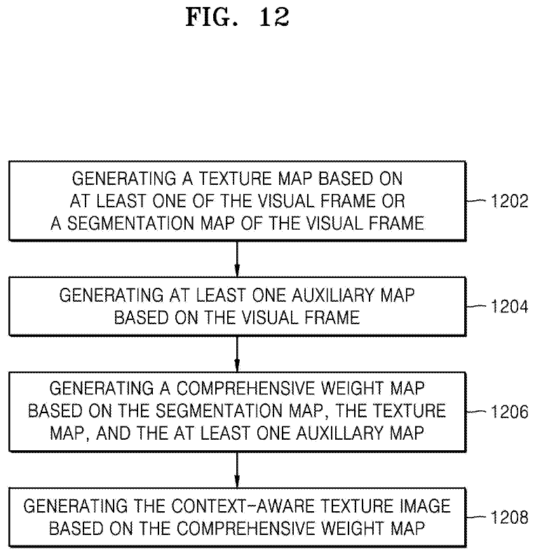

FIG. 12 illustrates a process flow of a method 1200 for generating the context-aware texture image, in accordance with an embodiment of the present disclosure. The method 1200 may be a computer-implemented method executed, for example, by the system (e.g., the system 304 or the electronic device 304). For the sake of brevity, constructional and operational features of the system that are already explained in the description of FIGS. 1-11 are not explained in detail in the description of FIG. 12.

In an embodiment, the method 1200 may include receiving the visual frame 602 from the imaging device. In a non-limiting example, the imaging device may include, but is not limited to, the digital camera, the smartphone, and the sensor-enabled display device. In a non-limiting example, the visual frame may include at least one of the still image and the video frame. Further, the visual frame may correspond to a discrete unit of visual information, typically comprising pixel data associated with a scene or an object captured at a particular instant in time. The imaging device may be integrated within the electronic device, such as a smartphone, tablet, wearable device, or any other user equipment capable of image acquisition.

At step 1202, the method 1200 may include generating a texture map based on at least one of the visual frame or a segmentation map of the visual frame. In a non-limiting example, the texture map may indicate a texture type for at least one region in the visual frame. In a non-limiting example, the at least one region may correspond to distinct portions or segments within a captured image or video frame that may be identified, classified, or processed independently.

At step 1204, the method 1200 may include generating at least one auxiliary map based on the visual frame. In an embodiment, at least one auxiliary map may be generated based on at least one of the inertial sensor data and the zoom scale obtained from the imaging device. In a non-limiting example, the at least one auxiliary map may indicate the at least one contextual parameter associated with refinement of a texture of the visual frame. In a non-limiting example, the inertial sensor data may correspond to one or more measurements obtained from inertial sensors such as accelerometers, gyroscopes, or magnetometers that are integrated within or operatively coupled to the imaging device. The inertial sensors may provide data indicative of the motion, orientation, acceleration, and angular velocity of the imaging device during image capture. In a non-limiting example, the zoom scale may correspond to the numerical or categorical value indicative of the magnification level applied by the imaging device during image acquisition. The zoom scale may be expressed as the optical zoom factor (such as 2×, 5×) or the digital zoom ratio and may reflect the extent to which the field of view has been narrowed or expanded.

In an embodiment, the at least one auxiliary map may include at least one of the per-pixel illumination map, the zoom and weight map, or the optical flow map.

In an embodiment, the per-pixel illumination map may correspond to the data structure or image representation, where each pixel encodes the illumination or lighting intensity at that specific spatial location. The illumination intensity may be derived from scene lighting models, reflectance properties, or estimated using photometric techniques.

In an embodiment, the zoom and weight map may be used to selectively emphasize or de-emphasize portions of the image, such as in multi-scale image processing, attention-based neural networks, or adaptive rendering. The zoom component may define the degree of enlargement or focus for specific regions, while the weight component may guide blending, fusion, or prioritization operations based on pixel-level or region-level significance.

In an embodiment, the optical flow map may correspond to the map that shows how each pixel in the image moves from one frame to the next in the video or the image sequence. The optical flow map may represent the movement using arrows or vectors that indicate direction and speed of motion. The optical flow map corresponds to the organized layout of visible motion in the scene caused by the movement of one or more camera sensors or objects.

In an embodiment, the at least one auxiliary map may be generated using at least one of the intensity estimator, the zoom and lighting estimator, and the temporal consistency estimator.

In a non-limiting example, the intensity estimator may generate the at least one auxiliary map representing the spatial distribution of pixel intensities, e.g. the per pixel illumination map, which may be used to enhance contrast, detect features, or guide further image processing operations. The intensity estimator may be implemented using statistical analysis, machine learning models, or neural networks trained on visual data.

In a non-limiting example, the zoom and lighting estimator may generate the at least one auxiliary map that reflect spatial and contextual variations in zoom and lighting, e.g. the zoom and weight map, thereby enabling adaptive rendering, exposure correction, or scene understanding. The zoom and lighting estimator may utilize metadata, image gradients, or learned representations to infer zoom and lighting parameters.

In a non-limiting example, the temporal consistency estimator may generate the at least one auxiliary map that capture motion vectors, frame-to-frame coherence, or stability of pixel attributes over time, e.g. the optical flow map. The temporal consistency estimator may employ optical flow techniques, recurrent neural networks, or temporal filtering methods.

Further, the at least one auxiliary map may refine the texture map by quantifying local scene properties such as motion regions and static regions. For the static regions across visual frames, such as walls, furniture, or other non-moving objects, noise patterns may be maintained consistently across successive frames. The consistency ensures that visual artifacts such as flickering are avoided, thereby preserving the temporal coherence of the scene. In contrast, for high-motion regions, which include moving objects or areas affected by motion blur, the optical flow map may be generated using motion estimation techniques.

At step 1206, the method 1200 may include generating the comprehensive weight map based on the segmentation map, the texture map, and the at least one auxiliary map. In a non-limiting example, the comprehensive weight map may indicate noise intensity for each pixel in the visual frame.

In a non-limiting example, the segmentation map may indicate labeling for each of the one or more regions in the visual frame with the corresponding category. For instance, the corresponding category may include, but is not limited to, semantic labels such as sky, skin, clothing, foliage, or artificial surfaces. Each region may be identified based on visual characteristics and may be classified accordingly, to support scene understanding, segmentation, or further image processing.

At step 1208, the method 1200 may include generating the context-aware texture image based on the comprehensive weight map. In an embodiment, the context-aware texture image may include noise generated for at least one region in the visual frame

In a non-limiting example, the context-aware texture image may indicate the textured map detailing region-specific noise level with corresponding noise sample, thereby improving and preserving clarity in the one or more regions of the visual frame. In a non-limiting example, the one or more noise samples may correspond to the one or more instances of artificially or naturally generated data that represent random or structured variations.

In a non-limiting example, to receive the visual frame from the imaging device, the system may be configured to obtain the visual frame from at least one of a memory of the imaging device or a real-time visual frame captured by the imaging device.

In an embodiment, prior to generating the context-aware texture image, the method 1200 may include generating the one or more noise samples by the at least one noise generation ML model. Further, each of the at least one noise generation ML model may correspond to a distinct texture class.

In a non-limiting example, the at least one noise generation ML model may include, but are not limited to, the film grain generation model, the sensor-specific noise model, the mixed Gaussian noise model, the fractal noise model, and the texture-driven noise.

In an embodiment, the method 1200 may include receiving the visual frame from the imaging device. The method 1200 may include identifying, using the machine learning model, the at least one region in the visual frame based on visual features. The method 1200 may include generating the segmentation map based on the identified at least one region.

In an embodiment, for generating the texture map, the method 1200 may include receiving the visual frame from the imaging device and the segmentation map from the machine learning model. The method 1200 may include determining the semantic context from the segmentation map for each of the at least one region in the visual frame. In a non-limiting example, the semantic context corresponds to a meaningful classification or interpretation assigned to the region (among the one or more regions) within the visual frame, based on the segmentation map. The semantic context provides information such as whether a region represents the road, the pedestrian, the vehicle, the vegetation, or any other identifiable category.

The method 1200 may include determining the at least one texture metric from the visual frame for each of the at least one region in the visual frame. The at least one texture metric may indicate texture characteristics of the visual frame. In a non-limiting example, the texture metrics may include, but are not limited to, statistical measures such as contrast, entropy, homogeneity, energy, and correlation derived from gray-level co-occurrence matrices (GLCM), frequency-based features such as those obtained from wavelet transforms or Fourier analysis, and local descriptors such as Local Binary Patterns (LBP).

The method 1200 may include generating the texture map based on the at least one texture metric for the at least one region in the visual frame.

In an embodiment, for generating the at least one auxiliary map comprising the per-pixel illumination map, the method 1200 may include computing the illumination values based on pixel and region analysis of the visual frame. In a non-limiting example, the illumination values may indicate the at least one quantifiable parameter indicative of the light intensity or brightness present in the visual frame, determined through the pixel-level and the region-level analysis. At the pixel level, the illumination value may correspond to grayscale intensity or luminance component derived from the RGB color model. At the region level, the illumination value may be computed as an average, median, or distribution of pixel intensities within a defined segment of the visual frame.

The method 1200 may include adjusting the illumination values based on the inertial sensor data to compensate for motion-related illumination variation. The system may be configured to generate the per-pixel illumination map based on the adjusted illumination values. The per-pixel illumination map may indicate noise modulation for each region in the visual frame.

In an embodiment, for generating the at least one auxiliary map comprising the zoom and weight map, the method 1200 may include computing the sensor gain weightage factor and the zoom weightage factor based on the visual frame and the zoom scale. The sensor gain weightage factor may indicate noise sensitivity of the image sensor (among the one or more camera sensors) of the imaging device and the zoom weightage factor may indicate magnification-related noise for the current zoom level. The system may be configured to adjust the noise level in the visual frame based on the sensor gain weightage factor and the zoom weightage factor. The method 1200 may include generating the zoom and weight map based on the adjusted noise level. In a non-limiting example, the zoom and weight map may indicate regions in the visual frame with varying noise levels.

In an embodiment, for generating the at least one auxiliary map comprising the optical flow map, the method 1200 may include computing the at least one optical flow parameter based on the visual frame. In a non-limiting example, the at least one optical flow parameter may correspond to a set of motion-related descriptors that are computed based on the analysis of at least one visual frame and temporal relationship with one or more subsequent or preceding visual frames. The at least one optical flow parameter may be derived by evaluating the changes in pixel intensities across consecutive visual frames, thereby capturing the apparent motion of objects, edges, or textures within the scene. The at least one optical flow parameter typically include, but are not limited to, motion vectors, which represent direction and magnitude of pixel displacement, velocity fields, which describe spatial distribution of motion across the visual frame, and gradient-based information, such as spatial and temporal derivatives of image intensity. The method 1200 may include identifying the at least one motion-prone region in the visual frame based on the optical flow parameters and the inertial sensor data. The method 1200 may include generating the optical flow map based on the identified at least one motion-prone region. In a non-limiting example, the optical flow map may indicate the at least one motion-prone region of the visual frame.

In an embodiment, for generating the comprehensive weight map, the method 1200 may include computing the per-pixel weight for each of the at least one region in the visual frame based on the segmentation map, the texture map, and at least one auxiliary map. The method 1200 may include refining the per-pixel weight contributions in each of the at least one region based on predefined weight ranges. The method 1200 may include generating the comprehensive weight map based on the refined per-pixel weight contributions.

In an embodiment, for generating the context-aware texture image, the method 1200 may include receiving the comprehensive weight map and the at least one noise sample. The method 1200 may include determining the noise sample among the at least one noise sample for the one or more regions based on the comprehensive weight map. The method 1200 may include fusing the noise sample in the at least one region of the visual frame. The method 1200 may include generating the context-aware texture image based on the fusion.

The present disclosure provides various advantages as mentioned below:
a) The present disclosure provides a system, an electronic device and a method for dynamically applying different types of noise to digital images based on contextual parameters such as scene content, lighting conditions, zoom levels, and motion analysis.
b) The present disclosure facilitates high-quality texture restoration by introducing contextually relevant noise, which compensates for the loss of fine details typically caused by image processing operations such as de-noising or compression.
c) The present disclosure provides computationally efficient texture enhancement, particularly suitable for implementation on mobile devices and other resource-constrained platforms.
d) The present disclosure is adaptable to dynamic scene changes. By continuously analyzing motion and lighting variations, the system maintains consistent enhancement quality across varying environmental conditions.
e) The present disclosure provides a context-aware, computationally efficient, and visually effective solution for real-time texture enhancement in digital imaging systems.

As would be apparent to a person in the art, various working modifications may be made to the method in order to implement the inventive concept as taught herein. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not necessarily limited to the manner described herein.

Moreover, the actions of any signal flow diagram need not be implemented in the order shown; nor do all of the acts necessarily need to be performed. Also, those acts that are not dependent on other acts may be performed in parallel with the other acts.

In an embodiment, a method, performed by an electronic device, for generating a context-aware texture image based on a visual frame may be provided. In an embodiment, the method may include generating a texture map based on at least one of the visual frame or a segmentation map of the visual frame. In an embodiment, the texture map may indicate a texture type for at least one region in the visual frame. In an embodiment, the method may include generating at least one auxiliary map based on the visual frame. In an embodiment, the at least one auxiliary map may indicate at least one contextual parameter associated with refinement of a texture of the visual frame. In an embodiment, the method may include generating a comprehensive weight map based on the segmentation map, the texture map, and the at least one auxiliary map. In an embodiment, the comprehensive weight map may indicate a noise intensity for each pixel in the visual frame. In an embodiment, the method may include generating the context-aware texture image based on the comprehensive weight map. In an embodiment, the context-aware texture image may comprise noise generated for at least one region in the visual frame.

In an embodiment, the method may include receiving the visual frame from an imaging device. In an embodiment, the method may include obtaining the visual frame from at least one of a memory of the imaging device or a real-time visual frame captured by the imaging device.

In an embodiment, the method may include determining a semantic context for the at least one region in the visual frame based on the segmentation map. In an embodiment, the method may include determining at least one texture metric for each of the at least one region in the visual frame, wherein the at least one texture metric indicates at least one texture characteristic of the visual frame. In an embodiment, the method may include generating the texture map based on the at least one texture metric for the at least one region in the visual frame.

In an embodiment, the at least one auxiliary map may include at least one of a per-pixel illumination map, a zoom and weight map, or an optical flow map.

In an embodiment, the method may include computing at least one illumination value based on at least one of a brightness value for each pixel in the visual frame or a brightness value for each of the at least one region. In an embodiment, the method may include generating the per-pixel illumination map based on the at least one illumination value. In an embodiment, the per-pixel illumination map may indicate a noise modulation for each of the at least one region in the visual frame.

In an embodiment, the method may include computing a sensor gain weightage factor and a zoom weightage factor based on the visual frame and a zoom scale corresponding to the visual frame. In an embodiment, the sensor gain weightage factor may indicate a noise sensitivity of an image sensor used to capture the visual frame and the zoom weightage factor may indicate a magnification-related noise for a zoom level associated with the visual frame. In an embodiment, the method may include generating the zoom and weight map based on the sensor gain weightage factor and the zoom weightage factor. In an embodiment, the zoom and weight map may indicate the at least one region in the visual frame having a varying noise level.

In an embodiment, the method may include computing at least one optical flow parameter based on the visual frame. In an embodiment, the method may include identifying at least one motion-prone region in the visual frame based on the at least one optical flow parameter and an inertial sensor data. In an embodiment, the method may include generating the optical flow map based on the identified at least one motion-prone region. In an embodiment, the optical flow map may indicate the at least one region of the visual frame being motion prone.

In an embodiment, the method may include obtaining a baseline noise intensity for each of the at least one region in the visual frame based on the segmentation map and the texture map. In an embodiment, the method may include obtaining a per-pixel weight by adjusting the baseline noise intensity based on the at least one auxiliary map. In an embodiment, the method may include generating the comprehensive weight map based on the per-pixel weight.

In an embodiment, the method may include determining a noise sample among at least one noise sample for each of the at least one region of the visual frame based on the comprehensive weight map. In an embodiment, the method may include generating a context-based texture map, based on the determined noise sample, indicating the noise intensity and the noise sample for each of the at least one region. In an embodiment, the method may include fusing the context-based texture map in the visual frame. In an embodiment, the method may include generating the context-aware texture image based on the fusion.

In an embodiment, the at least one noise samples may be generated by at least one noise generation machine learning (ML) model. In an embodiment, each of the at least one noise generation ML model may correspond to a distinct texture class.

In an embodiment, a system for generating a context-aware texture image based on a visual frame may be provided. In an embodiment, the system may comprise at least one processor comprising processing circuitry, and memory coupled with the at least one processor. In an embodiment, instructions, stored in the memory, when executed by the at least one processor, may cause the system to generate a texture map based on at least one of the visual frame or a segmentation map of the visual frame, In an embodiment, the texture map may indicate a texture type for at least one region in the visual frame. In an embodiment, instructions, when executed by the at least one processor, may cause the system to generate at least one auxiliary map based on the visual frame. In an embodiment, the at least one auxiliary map may indicate at least one contextual parameter associated with refinement of a texture of the visual frame. In an embodiment, instructions, when executed by the at least one processor, may cause the system to generate a comprehensive weight map based on the segmentation map, the texture map, and the at least one auxiliary map. In an embodiment, the comprehensive weight map may indicate a noise intensity for each pixel in the visual frame. In an embodiment, instructions, when executed by the at least one processor, may cause the system to generate the context-aware texture image based on the comprehensive weight map. In an embodiment, the context-aware texture image may comprise noise generated for at least one region in the visual frame.

In an embodiment, instructions, when executed by the at least one processor, may cause the system to receive the visual frame from an imaging device. In an embodiment, instructions, when executed by the at least one processor, may cause the system to obtain the visual frame from at least one of a memory of the imaging device or a real-time visual frame captured by the imaging device.

In an embodiment, instructions, when executed by the at least one processor, may cause the system to determine a semantic context for the at least one region in the visual frame based on the segmentation map. In an embodiment, instructions, when executed by the at least one processor, may cause the system to determine at least one texture metric for each of the at least one region in the visual frame, wherein the at least one texture metric indicates at least one texture characteristic of the visual frame. In an embodiment, instructions, when executed by the at least one processor, may cause the system to generate the texture map based on the at least one texture metric for the at least one region in the visual frame.

In an embodiment, the at least one auxiliary map may include at least one of a per-pixel illumination map, a zoom and weight map, or an optical flow map.

In an embodiment, instructions, when executed by the at least one processor, may cause the system to compute at least one illumination value based on at least one of a brightness value for each pixel in the visual frame or a brightness value for each of the at least one region. In an embodiment, instructions, when executed by the at least one processor, may cause the system to generate the per-pixel illumination map based on the at least one illumination value, wherein the per-pixel illumination map indicates a noise modulation for each of the at least one region in the visual frame.

In an embodiment, instructions, when executed by the at least one processor, may cause the system to compute a sensor gain weightage factor and a zoom weightage factor based on the visual frame and a zoom scale corresponding to the visual frame, wherein the sensor gain weightage factor indicates a noise sensitivity of an image sensor used to capture the visual frame and the zoom weightage factor indicates a magnification-related noise for a zoom level associated with the visual frame. In an embodiment, instructions, when executed by the at least one processor, may cause the system to generate the zoom and weight map based on the sensor gain weightage factor and the zoom weightage factor, wherein the zoom and weight map indicates the at least one region in the visual frame having a varying noise level.

In an embodiment, instructions, when executed by the at least one processor, may cause the system to compute at least one optical flow parameter based on the visual frame. In an embodiment, instructions, when executed by the at least one processor, may cause the system to identify at least one motion-prone region in the visual frame based on the at least one optical flow parameter and an inertial sensor data. In an embodiment, instructions, when executed by the at least one processor, may cause the system to generate the optical flow map based on the identified at least one motion-prone region, wherein the optical flow map indicates the at least one region of the visual frame being motion prone.

In an embodiment, instructions, when executed by the at least one processor, may cause the system to obtain a baseline noise intensity for each of the at least one region in the visual frame based on the segmentation map and the texture map. In an embodiment, instructions, when executed by the at least one processor, may cause the system to obtain a per-pixel weight by adjusting the baseline noise intensity based on the at least one auxiliary map. In an embodiment, instructions, when executed by the at least one processor, may cause the system to generate the comprehensive weight map based on the per-pixel weight.

In an embodiment, instructions, when executed by the at least one processor, may cause the system to determine a noise sample among at least one noise samples for each of the at least one region of the visual frame based on the comprehensive weight map. In an embodiment, instructions, when executed by the at least one processor, may cause the system to generate a context-based texture map, based on the determined noise sample, indicating the noise intensity and the noise sample for each of the at least one region. In an embodiment, instructions, when executed by the at least one processor, may cause the system to fuse the context-based texture map in the visual frame. In an embodiment, instructions, when executed by the at least one processor, may cause the system to generate the context-aware texture image based on the fusion.

In an embodiment, the at least one noise samples may be generated by at least one noise generation machine learning (ML) model, wherein each of the at least one noise generation ML model corresponds to a distinct texture class.

In an embodiment, an electronic device for generating a context-aware texture image based on a visual frame may be provided. In an embodiment, the electronic device may comprise at least one processor comprising processing circuitry, and memory coupled with the at least one processor. In an embodiment, instructions, stored in the memory, when executed by the at least one processor, may cause the system to generate a texture map based on at least one of the visual frame or a segmentation map of the visual frame, In an embodiment, the texture map may indicate a texture type for at least one region in the visual frame. In an embodiment, instructions, when executed by the at least one processor, may cause the electronic device to generate at least one auxiliary map based on the visual frame. In an embodiment, the at least one auxiliary map may indicate at least one contextual parameter associated with refinement of a texture of the visual frame. In an embodiment, instructions, when executed by the at least one processor, may cause the electronic device to generate a comprehensive weight map based on the segmentation map, the texture map, and the at least one auxiliary map. In an embodiment, the comprehensive weight map may indicate a noise intensity for each pixel in the visual frame. In an embodiment, instructions, when executed by the at least one processor, may cause the electronic device to generate the context-aware texture image based on the comprehensive weight map. In an embodiment, the context-aware texture image may comprise noise generated for at least one region in the visual frame.

We claim:

1. A method, performed by an electronic device, for generating a context-aware texture image based on a visual frame, the method comprising:
generating a texture map based on at least one of the visual frame or a segmentation map of the visual frame, wherein the texture map indicates a texture type for at least one region in the visual frame;
generating at least one auxiliary map based on the visual frame, wherein the at least one auxiliary map indicates at least one contextual parameter associated with refinement of a texture of the visual frame;
generating a comprehensive weight map based on the segmentation map, the texture map, and the at least one auxiliary map, wherein the comprehensive weight map indicates a noise intensity for each pixel in the visual frame; and
generating the context-aware texture image based on the comprehensive weight map, wherein the context-aware texture image comprises noise generated for at least one region in the visual frame.

2. The method as claimed in claim 1,
wherein the method comprises receiving the visual frame from an imaging device, and
wherein the receiving the visual frame from the imaging device comprises:
obtaining the visual frame from at least one of a memory of the imaging device or a real-time visual frame captured by the imaging device.

3. The method as claimed in claim 1, wherein generating the texture map comprises:
determining a semantic context for the at least one region in the visual frame based on the segmentation map;
determining at least one texture metric for each of the at least one region in the visual frame, wherein the at least one texture metric indicates at least one texture characteristic of the visual frame; and
generating the texture map based on the at least one texture metric for the at least one region in the visual frame.

4. The method as claimed in claim 1, wherein the at least one auxiliary map comprises at least one of a per-pixel illumination map, a zoom and weight map, or an optical flow map.

5. The method as claimed in claim 4, wherein generating the at least one auxiliary map comprises:
computing at least one illumination value based on at least one of a brightness value for each pixel in the visual frame or a brightness value for each of the at least one region; and
generating the per-pixel illumination map based on the at least one illumination value, wherein the per-pixel illumination map indicates a noise modulation for each of the at least one region in the visual frame.

6. The method as claimed in claim 4, wherein generating the at least one auxiliary map comprises:
computing a sensor gain weightage factor and a zoom weightage factor based on the visual frame and a zoom scale corresponding to the visual frame, wherein the sensor gain weightage factor indicates a noise sensitivity of an image sensor used to capture the visual frame and the zoom weightage factor indicates a magnification-related noise for a zoom level associated with the visual frame; and
generating the zoom and weight map based on the sensor gain weightage factor and the zoom weightage factor, wherein the zoom and weight map indicates the at least one region in the visual frame having a varying noise level.

7. The method as claimed in claim 4, wherein generating the at least one auxiliary map comprises:
computing at least one optical flow parameter based on the visual frame;
identifying at least one motion-prone region in the visual frame based on the at least one optical flow parameter and an inertial sensor data; and
generating the optical flow map based on the identified at least one motion-prone region, wherein the optical flow map indicates the at least one region of the visual frame being motion prone.

8. The method as claimed in claim 1, wherein generating the comprehensive weight map comprises:
obtaining a baseline noise intensity for each of the at least one region in the visual frame based on the segmentation map and the texture map;
obtaining a per-pixel weight by adjusting the baseline noise intensity based on the at least one auxiliary map; and
generating the comprehensive weight map based on the per-pixel weight.

9. The method as claimed in claim 1, wherein generating the context-aware texture image comprises:
determining a noise sample among at least one noise sample for each of the at least one region of the visual frame based on the comprehensive weight map;
generating a context-based texture map, based on the determined noise sample, indicating the noise intensity and the noise sample for each of the at least one region;
fusing the context-based texture map in the visual frame; and
generating the context-aware texture image based on the fusion.

10. The method as claimed in claim 9, wherein the at least one noise sample are generated by at least one noise generation machine learning (ML) model, wherein each of the at least one noise generation ML model corresponds to a distinct texture class.

11. A system for generating a context-aware texture image based on a visual frame, the system comprising:
at least one processor comprising processing circuitry;
memory coupled with the at least one processor, the memory storing instructions that when executed by the at least one processor, cause the system to:
generate a texture map based on at least one of the visual frame or a segmentation map of the visual frame, wherein the texture map indicates a texture type for at least one region in the visual frame;
generate at least one auxiliary map based on the visual frame, wherein the at least one auxiliary map indicates at least one contextual parameter associated with refinement of a texture of the visual frame;
generate a comprehensive weight map based on the segmentation map, the texture map, and the at least one auxiliary map, wherein the comprehensive weight map indicates a noise intensity for each pixel in the visual frame; and
generate the context-aware texture image based on the comprehensive weight map, wherein the context-aware texture image comprises noise generated for at least one region in the visual frame.

12. The system as claimed in claim 11, wherein the instructions, when executed by the at least one processor, cause the system to receive the visual frame from an imaging device,
and wherein to receive the visual frame from the imaging device, the instructions, when executed by the at least one processor, cause the system to:
obtain the visual frame from at least one of a memory of the imaging device or a real-time visual frame captured by the imaging device.

13. The system as claimed in claim 11, wherein to generate the texture map, the instructions, when executed by the at least one processor, cause the system to:
determine a semantic context for the at least one region in the visual frame based on the segmentation map;
determine at least one texture metric for each of the at least one region in the visual frame, wherein the at least one texture metric indicates at least one texture characteristic of the visual frame; and
generate the texture map based on the at least one texture metric for the at least one region in the visual frame.

14. The system as claimed in claim 11, wherein the at least one auxiliary map comprises at least one of a per-pixel illumination map, a zoom and weight map, or an optical flow map.

15. The system as claimed in claim 14, wherein to generate the at least one auxiliary map, the instructions, when executed by the at least one processor, cause the system to:
compute at least one illumination value based on at least one of a brightness value for each pixel in the visual frame or a brightness value for each of the at least one region; and
generate the per-pixel illumination map based on the at least one illumination value, wherein the per-pixel illumination map indicates a noise modulation for each of the at least one region in the visual frame.

16. The system as claimed in claim 14, wherein to generate the at least one auxiliary map, the instructions, when executed by the at least one processor, cause the system to:
compute a sensor gain weightage factor and a zoom weightage factor based on the visual frame and a zoom scale corresponding to the visual frame, wherein the sensor gain weightage factor indicates a noise sensitivity of an image sensor used to capture the visual frame and the zoom weightage factor indicates a magnification-related noise for a zoom level associated with the visual frame; and
generate the zoom and weight map based on the sensor gain weightage factor and the zoom weightage factor, wherein the zoom and weight map indicates the at least one region in the visual frame having a varying noise level.

17. The system as claimed in claim 14, wherein to generate the at least one auxiliary map, the instructions, when executed by the at least one processor, cause the system to:
compute at least one optical flow parameter based on the visual frame;
identify at least one motion-prone region in the visual frame based on the at least one optical flow parameter and an inertial sensor data; and
generate the optical flow map based on the identified at least one motion-prone region, wherein the optical flow map indicates the at least one region of the visual frame being motion prone.

18. The system as claimed in claim 11, wherein to generate the comprehensive weight map, the instructions, when executed by the at least one processor, cause the system to:
obtain a baseline noise intensity for each of the at least one region in the visual frame based on the segmentation map and the texture map;
obtain a per-pixel weight by adjusting the baseline noise intensity based on the at least one auxiliary map; and
generate the comprehensive weight map based on the per-pixel weight.

19. The system as claimed in claim 11, wherein to generate the context-aware texture image, the instructions, when executed by the at least one processor, cause the system to:
determine a noise sample among at least one noise samples for each of the at least one region of the visual frame based on the comprehensive weight map;
generate a context-based texture map, based on the determined noise sample, indicating the noise intensity and the noise sample for each of the at least one region;
fuse the context-based texture map in the visual frame; and
generate the context-aware texture image based on the fusion.

20. An electronic device for generating a context-aware texture image based on a visual frame, the electronic device comprising:
at least one processor comprising processing circuitry;
memory coupled with the at least one processor, the memory storing instructions that when executed by the at least one processor, cause the electronic device to:
generate a texture map based on at least one of the visual frame or a segmentation map of the visual frame, wherein the texture map indicates a texture type for at least one region in the visual frame;
generate at least one auxiliary map based on the visual frame, wherein the at least one auxiliary map indicates at least one contextual parameter associated with refinement of a texture of the visual frame;
generate a comprehensive weight map based on the segmentation map, the texture map, and the at least one auxiliary map, wherein the comprehensive weight map indicates a noise intensity for each pixel in the visual frame; and
generate the context-aware texture image based on the comprehensive weight map, wherein the context-aware texture image comprises noise generated for at least one region in the visual frame.
